(19) United States
(12) Patent Application Publication
(10) Pub. No.: US 2015/0278240 A1
(43) Pub. Date: Oct. 1, 2015

(54) DATA PROCESSING APPARATUS, INFORMATION PROCESSING APPARATUS, DATA PROCESSING METHOD AND INFORMATION PROCESSING METHOD

(71) Applicant: FUJITSU LIMITED, Kawasaki-shi (JP)

(72) Inventors: Shigeo Yoshikawa, Himeji (JP); Masao Tomofuji, Kobe (JP); Yuichi Kusano, Yokohama (JP)

(21) Appl. No.: 14/666,484

(22) Filed: Mar. 24, 2015

(30) Foreign Application Priority Data
Mar. 28, 2014 (JP) 2014-070060

(51) Int. Cl. G06F 17/30; H04L 29/06

(52) U.S. Cl. CPC G06F 17/30153; H04L 69/04

(57) ABSTRACT

A data processing apparatus to transmit data including a plurality of items to an information processing apparatus and to cause the information processing apparatus to process the data, the data processing apparatus including a processor, and memory configured to store a program to instruct the processor to perform: acquiring processing-related information including a designation of a processing target item from the information processing apparatus, extracting, from the data to be transmitted, an item value associated with an item to which the information processing apparatus refers when the information processing apparatus processes the data to be transmitted based on the processing-related information, generating compressed data by compressing the data to be transmitted, generating attached information including the extracted item value and to attach the attached information to the compressed data, and transmitting the compressed data attached with the attached information to the information processing apparatus.

### CROSS-REFERENCE TO RELATED APPLICATION

This application is based upon and claims the benefit of priority of the prior Japanese Patent Application No. 2014-070060, filed on Mar. 28, 2014, the entire contents of which are incorporated herein by reference.

### FIELD

The embodiments discussed herein are related to a data processing apparatus, an information processing apparatus and an data processing method.

### BACKGROUND

An information processing system called a data integration system is used to collect and process data transferred from source systems serving as data transmission sources. The conventional information processing system executes processing such that the data transferred by the source systems are compressed for reducing a transfer data size, and a data integration system decompresses the transferred compressed data on a file-by-file basis, processes the decompressed data and again compresses the data on the file-by-file basis.

The following patent document describes conventional techniques related to the techniques described herein.

[Patent Document]

[Patent document 1] Japanese Patent Application Laid-Open Publication No. 2010-15556

### SUMMARY

According to one embodiment, it is provided a data processing apparatus to transmit data including a plurality of items to an information processing apparatus and to cause the information processing apparatus to process the data, the data processing apparatus including a processor, and memory configured to store a program to instruct the processor to perform: acquiring processing-related information including a designation of a processing target item from the information processing apparatus, extracting, from the data to be transmitted, an item value associated with an item to which the information processing apparatus refers when the information processing apparatus processes the data to be transmitted based on the processing-related information, generating compressed data by compressing the data to be transmitted, generating attached information including the extracted item value and to attach the attached information to the compressed data, and transmitting the compressed data attached with the attached information to the information processing apparatus.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating processes of an information processing system according to a comparative example.

FIG. 2 is a diagram illustrating architecture of an information processing system according to an embodiment.

FIG. 3 is a diagram illustrating detailed processes of an agent.

FIG. 4 is a diagram illustrating a structure of a record of header information.

FIG. 5 is a diagram illustrating a data flow when a data integration system executes data processing.

FIG. 6 is a diagram illustrating details of the data processing by the data integration system processes data.

FIG. 7 is a diagram illustrating a data processing definition setting screen displayed on a user interface of the data integration system.

FIG. 8 is a diagram illustrating items of data when details of data processing definitions are described in a table format.

FIG. 9 is a diagram illustrating items of data when the data processing definitions are described in an XML format.

FIG. 10 is a diagram illustrating an information processing apparatus executes the processes byway of a source system, the data integration system or a target system.

FIG. 11 is a flowchart illustrating processes of an agent of the source system.

FIG. 12 is a flowchart illustrating processes of the data integration system.

### DESCRIPTION OF EMBODIMENTS

The conventional information processing system involves decompressing the compressed data and again compressing the decompressed data after being processed, resulting in increasing loads on resources of the information processing system. One aspect of the present invention lies in providing a technology capable of processing compressed data while restraining a load on information processing from rising. First, an information processing apparatus according to a comparative example is described below with reference to the drawings. An information processing system according to one embodiment will hereinafter be described with reference to the drawings. A configuration of the following embodiment is an exemplification, and the present apparatus is not limited to the configuration of the embodiment.

### COMPARATIVE EXAMPLE

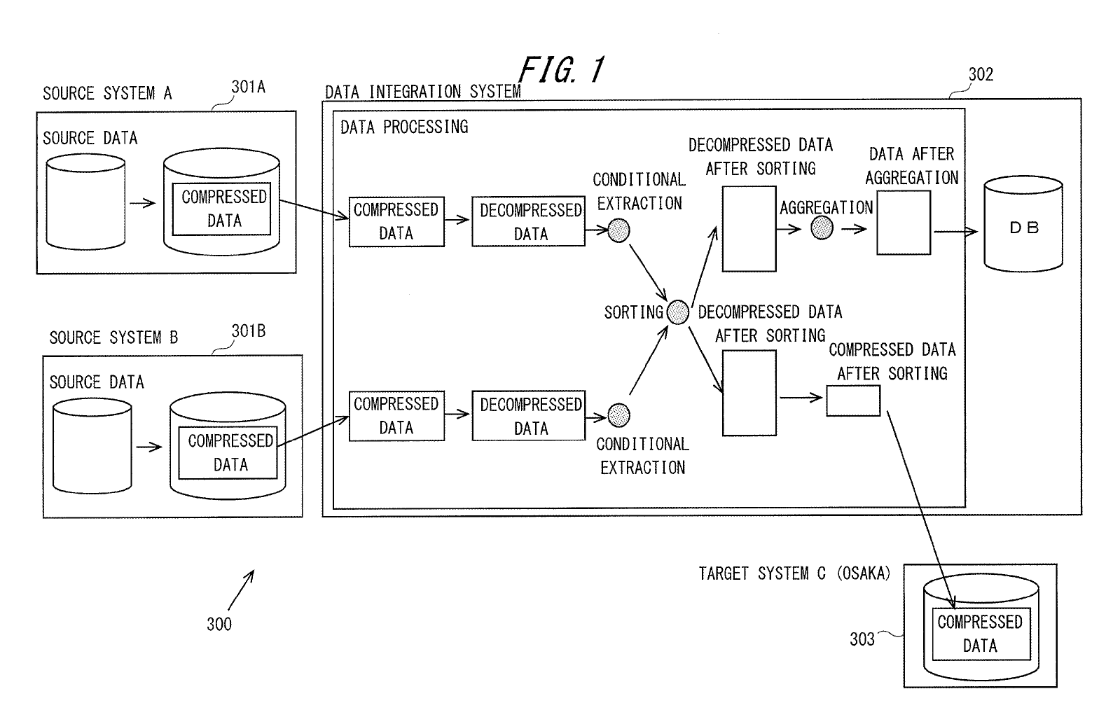

FIG. 1 illustrates a data flow of an information processing system 300 according to a comparative example. The information processing system 300 includes, e.g., source systems 301A, 301B, a data integration system 302, a target system 303, etc. The source systems 301A, 301B are source systems to generate data that are transferred to the data integration system 302. The source systems are simply referred to as source systems 301 when the source systems are termed generically. FIG. 1 depicts two source systems 301A, 301B, but it does not mean that the number of source systems 301 is limited to “2”.

The source systems 301 can be exemplified by various types of information processing apparatuses in or from which the data are generated or acquired. The source systems 301 may be computer systems at respective sites of, e.g., enterprises, communities (organizations), administrative institutions, schools, etc. The source systems 301 manage, e.g., the data of the respective sites, the data being generated, acquired or accumulated at the individual sites. Further, the source systems 301 compress the data of the sites, and transfer the compressed data to the data integration system 302.

The data integration system 302 is an information processing apparatus with a computer program called, e.g., an ETL (Extract Transform Load) tool installed. The data integration system 302 processes the data acquired from the plurality of source systems 301 in a variety of procedures. For example, the data acquired from the source systems 301 located at the plurality of sites have different data structures or different formats as the case may be. The data integration system 302 integrates the data based on the different data structures or different formats acquired from the plurality of source systems 301, and processes the data in a format conforming to a user's request.

The example in FIG. 1 is that the data integration system 302 at first decompresses the compressed data transferred from the source systems 301 into the decompressed data. Then, the data integration system 302 extracts data matching with a predetermined extraction condition from the decompressed data. A process of extracting the data matching with the predetermined extraction condition is called “conditional extraction”. Moreover, the data integration system 302 allocates items of data extracted by the conditional extraction in accordance with a predetermined allocation condition. The term “allocation” connotes assorting the items of data according to values of items or combinations of values of plural items included in the data.

The data integration system 302 aggregates the allocated items of decompressed data, processes the data, generates the post-processing data and stores the generated data in, e.g., a database (DB) of a certain site. Further, e.g., the data integration system 302 compresses again the allocated items of decompressed data, and transfers the re-compressed data to the target system 303 of another site. It is noted that the target system 303 in FIG. 1 is, e.g., a system including a database remotely located.

The following are problems of the information processing system 300 as described in the above comparative example. Firstly, the data integration system 302 executes a process of decompressing the compressed data transferred from the source systems 301, processing the decompressed data and re-compressing the data after being processed. The processes may lead to increasing loads on system resources such as a CPU (Central Processing Unit), a memory, external storage device, etc. of the data integration system 302. Secondly, when the data integration system 302 processes the compressed data after being decompressed, processing target data are specified and thus extracted, and hence it follows that all items of data are referred to. For example, it is assumed that the post-decompressing data are defined as an aggregation of records each including an item 1, an item 2, . . . an item N. Then, such a case is assumed as to extract the data including the item 1 being a value v11, the item 2 being a value v21 as the conditional extraction. In this case, it follows that the data searches all of the records of the decompressed data for extracting the target data, and determines whether the value v11 is set in the item 1 or not and whether the value v21 is set in the item 2 or not. Accordingly, there exists the possibility of increasing the loads on the system resources of the data integration system 302.

### EMBODIMENT

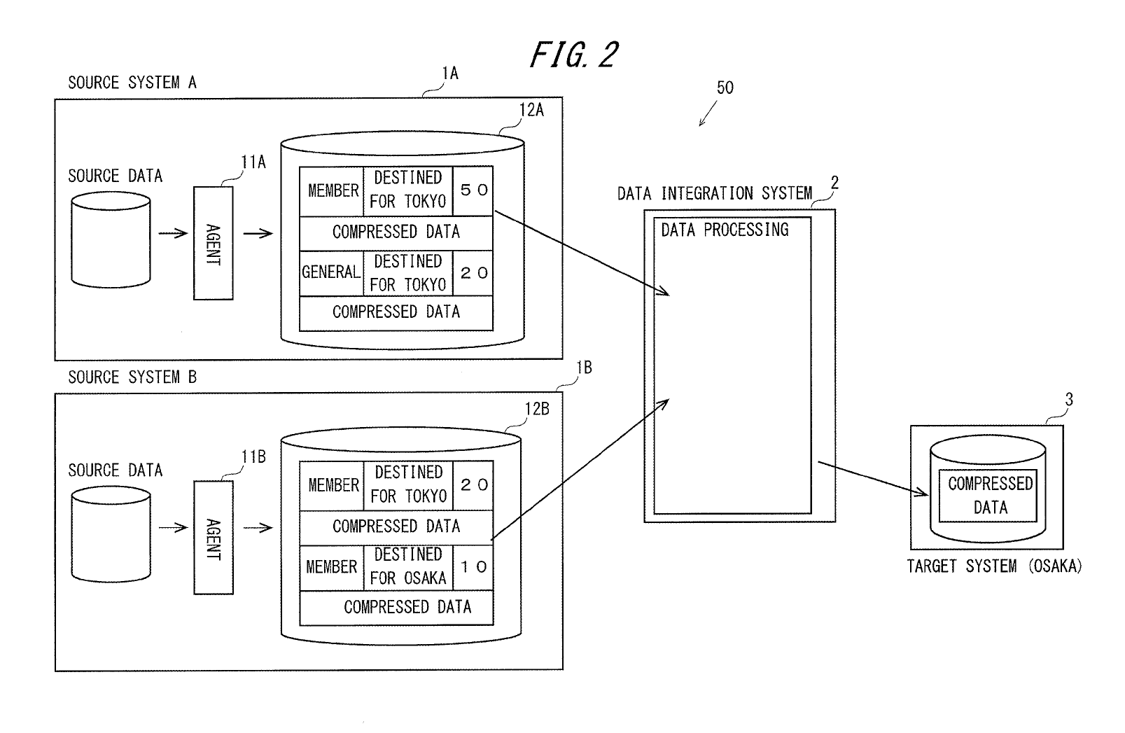

An information processing system 50 according to an embodiment will hereinafter be described with reference to FIGS. 2 through 12. FIG. 2 illustrates architecture of the information processing system 50. The information processing system 50 includes source systems 1A, 1B, a data integration system 2 and a target system 3. Similarly to the case of the comparative example, the sources systems 1A, 1B are referred to as source systems 1 when the sources systems 1A, 1B are generically termed in the present embodiment. It does not, however, mean that the number of the source systems 1 is limited to “2”. Further, it does not mean that the target system 3 is limited to one single system. It is noted that the details of the data integration system 2 are omitted in FIG. 2. The source systems 1A, 1B are given by way of one example of a data processing apparatus.

As in FIG. 2, the source systems 1A, 1B include agents 11A, 11B, respectively. The agents 11A, 11B are referred to as agents 11 when the agents 11A, 11B are generically termed. The agents 11 are defined as, e.g., computer programs to be executed by the source systems 1. The agents 11 process source data generated, acquired or accumulated in the source systems 1, and generate compressed data attached with header information (header record). For example, the source system 1A has compressed data being generated together with the header information including items such as “Member”, “Destined for Tokyo” and “Value 50”. Herein, the “Value 50” is a value processed by a processing target item in the data being assorted by item values such as “Member” and “Destined for Tokyo”. Herein, the “value processed by the processing target item in the data being assorted” is exemplified by, e.g., a subtotal value of items as aggregation targets in the assorted data.

Moreover, the source system 1A has compressed data being generated together with the header information including items such as “Member”, “Destined for Tokyo” and “Value 20”. The agents 11 generate plural sets of compressed data each attached with the header information from the source data. The generated compressed data with the header information are transferred to the data integration system 2. The header information is one example of attached information.

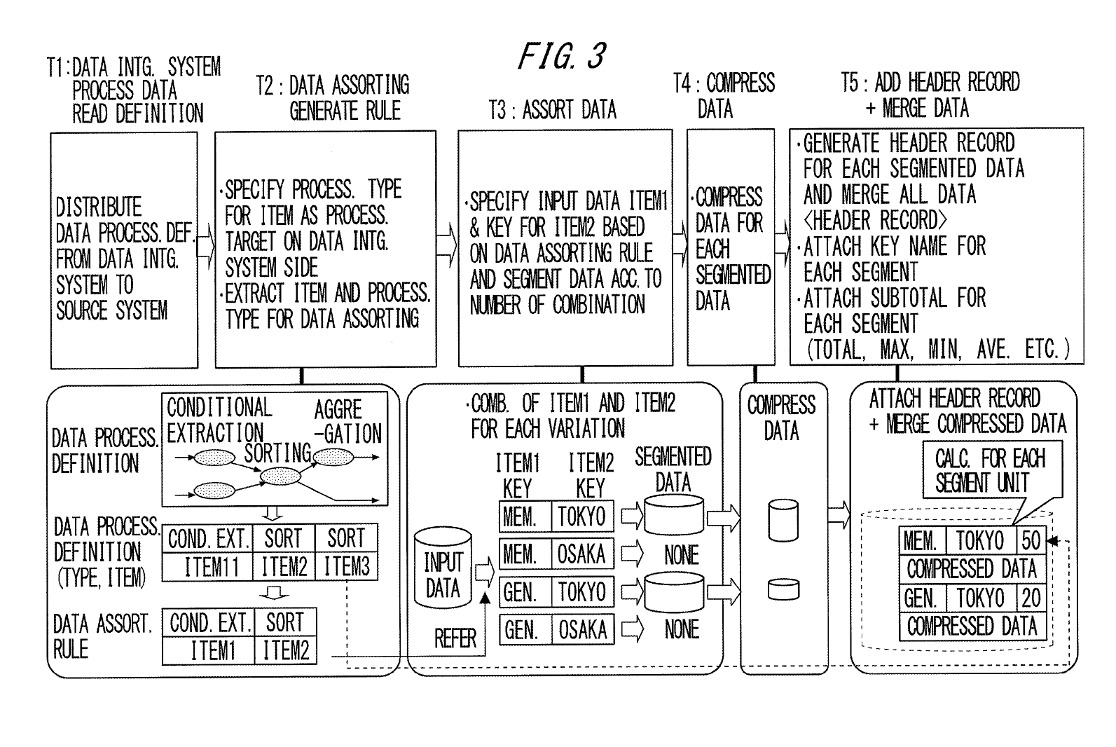

FIG. 3 depicts detailed processes of the agents 11. In FIG. 3, the processes of the agents 11 are expressed by steps T1-T5 being given as charts. To begin with, the agents 11 receive a distribution of data processing definitions from the data integration system 2. The data processing definitions are, e.g., information including items and processing types of the processing target data in the data integration system 2. A process, in which the data integration system 2 distributes the data processing definitions in step T1, is one example of a step of transmitting processing related information. Further, the data processing definitions are given by way of one example of processing related information.

Then, the agents 11 read the data processing definitions (T1). The data processing definitions include definitions of the data processing procedures executed in the data integration system 2. The data processing procedures define items, data processing types, etc. of the processing target data. The agents 11 functioning as an acquiring unit executes the process in T1.

Next, the agents 11 generate a data assorting rule (T2). To be specific, the agents 11 specifies the items and the processing types of the processing target data in the data integration system 2 from the data processing definitions acquired in T1. Then, the agents 11 extract the item and the processing type for assorting the data from the specified data items to generate the data assorting rule (T2).

In the example of FIG. 3, the data processing definitions are described by a flowchart including “Extraction of Condition”, “Allocation” and “Aggregation” or described by a table specifying“Item1”, “Item 2” and“Item3” of the processing target data items. The flowchart illustrates the processing procedures of the data integration system 2. The flowchart also illustrates displaying, e.g., a user interface of the data integration system 2. On the other hand, FIG. 3 depicts the data processing definitions in a table format to specify the processing types such as “Conditional Extraction”, “Allocation” and “Aggregation” and also “Item 1”, “Item 2” and “Item 3” with respect to the respective processing types. The table illustrated in FIG. 3 is given by way of a data example of the data processing definitions distributed to the agents 11 of the source systems 1 from the data integration system 2. The data assorting rule specifying the “Item 1” for “Conditional Extraction” and “Item 2” for “Allocation”, is generated based on the data processing definitions described above.

Subsequently, the agents 11 execute assorting the data. Specifically, the agents 11 read based on the data assorting rule generated in T2 the source data accumulated in the source systems 1, and generate assortments corresponding to the number of combinations of the specified values while specifying the values of the item 1 and the item 2 in the source data, thus segmenting the source data (T3). It is noted that the source data in the process of T3 is also referred to as input data. It is assumed in the following processes that the source data includes one or more records, and each record has a plurality of items (values).

For instance, in the example of FIG. 3, “Member” and “General” each associated with the item 1 and “Destined for Tokyo” and “Destined for Osaka” each associated with the item 2 are acquired from the source data (input data) in a way that refers to the data assorting rule, and four assortments of combinations of these values are generated. Moreover, these assortments being generated, the data read from the source data (input data) are segmented into the respective assortments, thereby generating the segmented data. In FIG. 3, however, there are neither data matching with “Member” in the item 1 and “Destined for Osaka” in the item 2 nor data matching with “General” in the item 1 and “Destined for Osaka” in the item 2. The agents 11 functioning as an extraction unit execute the processes in T2 and T3. Further, the agents 11 functioning as a segmenting unit executes the process in T3.

Next, the agents 11 compress the data per segmented data (T4). Incidentally, it does not mean that there are limits to a data compression procedure and a data compression type. The agents 11 functioning as a compression unit execute a process in T4.

Subsequently, the agents 11 execute generating a record of the header information and merging the data. To be specific, the agents 11 generate the record of the header information per segmented data, then attach each record of the header information to the compressed segmented data, and merges (combines) the compressed data attached with the header information (T5). The agents 11 functioning as an attaching unit execute the process in T5.

It is noted that the record of the header information includes a key name per segmented data for identifying the segmented data, and subtotal values (processing values of the segmented data, such as a sum, a maximum value, a minimum value and an average value) of the processing target items per segmented data. For example, with respect to the first compressed data, “Member” and “Destined for Tokyo” are given as the key names, and the record of the header information including “50” as the subtotal value in the item 3 is generated and attached to the segmented data. Moreover, “General” and “Destined for Tokyo” are given as the key names, and the record of the header information including “20” as the subtotal value in the item 3 is generated and attached to the segmented data. Then, the compressed data attached with the records of header information are merged and thus become the data that are transmitted to the data integration system 2.

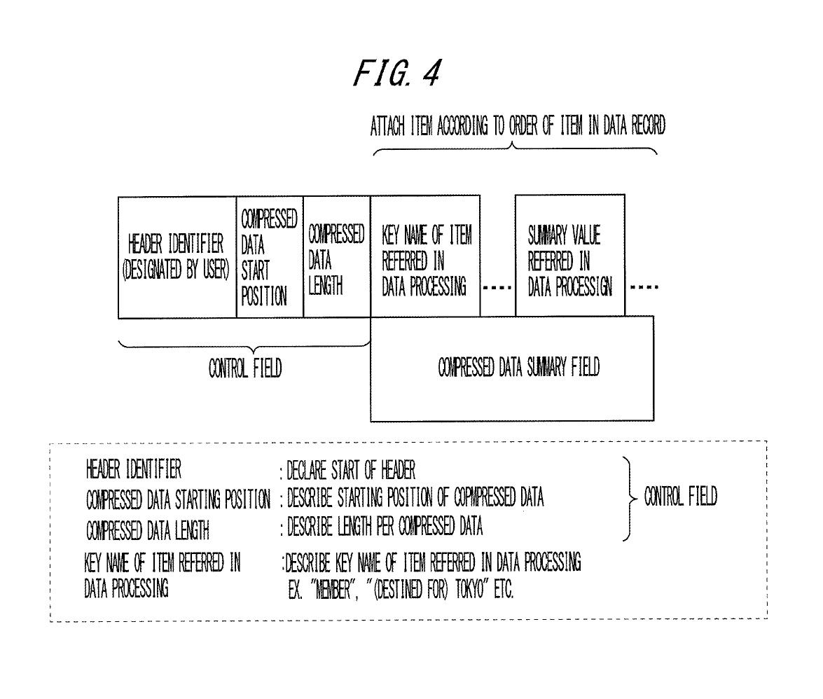

FIG. 4 illustrates a structure of the record of header information. The record of header information includes a control field and a compressed data summary field. The control field includes items of management information for accessing the compressed data in order for the data integration system 2 to execute the process of decompressing the compressed data. The control field includes items such as a “header identifier”, a “compressed data start position” and a “length of compressed data”. Herein, the header identifier is exemplified by information for declaring a start of the header, such as a bit pattern and a character string. Further, the compressed data start position represents information indicating a start position of the compressed data based on, e.g., a position of the header identifier. Moreover, the length of the compressed data is defined as a compressed data size, e.g., a byte count.

The compressed data summary field includes the item values acquired from the pre-compressing data or the processing values of the items. The items of the compressed data summary field are arranged in the same method as the items of the record of the pre-compressing data are arranged.

The compressed data summary field includes a column (values arranged in a vertical line) of the item values each becoming the key name when processing the data in the data integration system 2, and a column of item aggregated values that are referred to in the data processing. The term “key name” connotes a value used for the data integration system 2 to determine whether to be eligible for an aggregation process target item in the data processing such as an aggregation process. Furthermore, the key names can be said to be values used for the data integration system 2 to assort the respective records of the data. For instance, when aggregating a sales volume per commercial product, the item (aggregation target item) being referred to in the data processing is a value of sales per commercial product, and the key name is exemplified such as a product number and a product name. In the example of FIG. 3, the key names are given as a 2-tuple of “Member” and “Destined for Tokyo” and a 2-tuple of “General” and “Destined for Tokyo”, etc.

Moreover, the aggregation value of items referred to in the data processing is an aggregation value of the data assorted by the key names with respect to the data processing target items, and can be said to be a subtotal value of the data assorted by the key names. It is to be noted that the aggregation item being referred to in the data processing is a value of the item 3 in the example of FIG. 3. Further, FIG. 3 illustrates “Aggregation”, but it does not mean that the data processing type, i.e., a data item processing method, is limited to the aggregation.

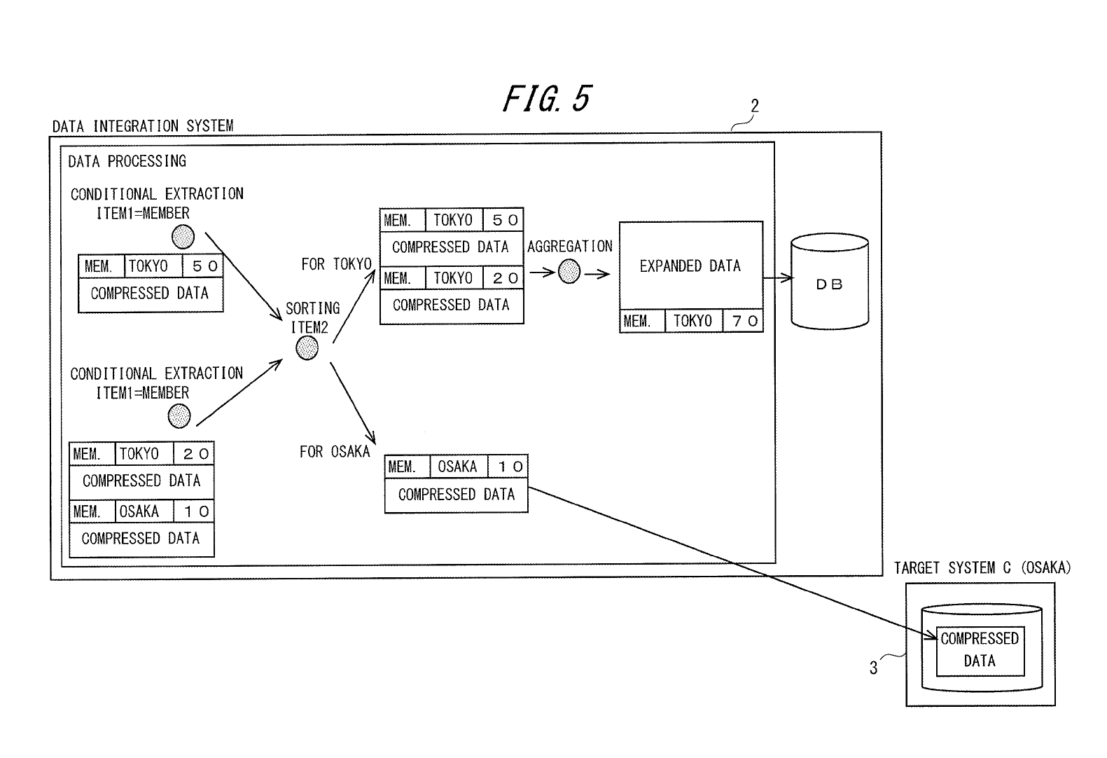

FIG. 5 illustrates a data flow in the data processing of the data integration system 2. The data integration system 2 is one example of an information processing apparatus to receive and process compressed data. The data integration system 2 acquires the compressed data attached with the record of header information, the compressed data being generated and transferred by the agents 11 of the source system 1. Further, the data integration system 2 extracts, based on the predetermined extraction condition, the record of header information matching with the extraction condition and the compressed data attached with the record of header information by referring to the header information. The extraction condition matches the extraction condition of the data processing definitions distributed to the agents 11 of the source system 1. It is noted that FIG. 5 illustrates a process of extracting the header information with the item 1 being “Member” (Item 1=“Member”) and the compressed data.

Next, the data integration system 2 sorts the extracted header information and the extracted compressed data. In the example of FIG. 5, the header information and the compressed data are assorted depending on whether “Item=Destined for Tokyo” or “Item=Destined for Osaka”. The data integration system 2 merges sets of compressed data including “Item 1=Member” and “Item 2=Destined for Tokyo”, and executes the data processing of the data processing target items. In the example of FIG. 5, the data integration system 2 further aggregates the aggregation values “50” and “20” in the item 3, resulting in a calculated value “70”. Moreover, the data integration system 2 reads the compressed data from the merged data, then decompresses the read-in data into one set of decompressed data, and registers this one set of decompressed data in the database (DB). On the other hand, the data integration system 2 transfers the compressed data including “Item 1=Member” and “Item 2=Destined for Osaka” to the target system 3. The data integration system 2 executes the foregoing processes also for the data having other key names, e.g., the compressed data attached with the header information such as “Item 1=Member” and “Item 2=Destined for Tokyo”.

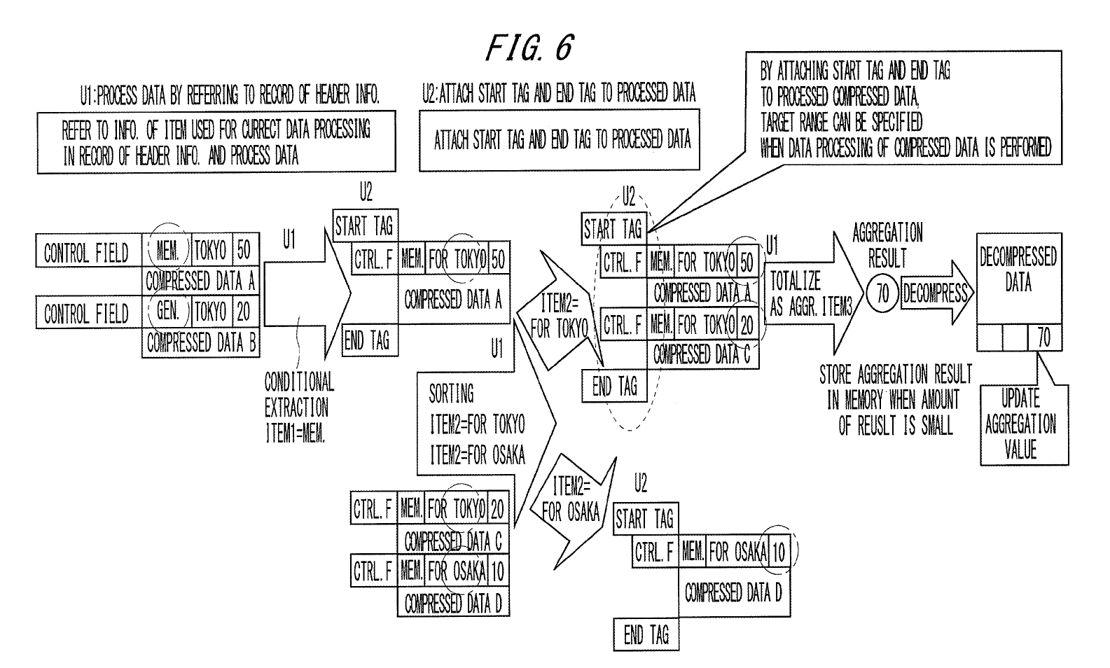

FIG. 6 depicts details of the data processing of the data integration system 2. As in FIG. 6, the data integration system 2 executes the data processing in a way that assorts, allocates and merges the compressed data by repeatedly executing a process (U1) of referring to the record of header information and processing the data and a process (U2) of attaching a start tag and an end tag to the processed data. In other words, the data integration system 2 processes the data while referring to the information of the items, used for an active process, in the record of header information. For instance, in the example of FIG. 6, the data being processed underway are compressed data A attached with the header information including “Item 1=Member”, “Item 2=Destined for Tokyo” and “Item 3=50” in the control field, and compressed data B attached with the header information including “Item 1=General”, “Item 2=Destined for Tokyo” and “Item 3=20” in the control field. The data integration system 2 extracts the compressed data A attached with the header information including “Item 1=Member” from these two sets of compressed data. Similarly, the data integration system 2 extracts compressed data C including the header information including “Member”, “Destined for Tokyo” and “20” and compressed data D including the header information including “Member”, “Destined for Osaka” and “10”. It is noted that though omitted in FIG. 6, the data with “Item 1=General” are similarly processed in accordance with the condition specified in the data integration system 2.

Next, the data integration system 2 allocates the data based on “Item 2=Destined for Tokyo” and “Item 2=Destined for Osaka”. Then, the data integration system 2 attaches a start tag and an end tag to the allocated set(s) of compressed data with header information. The start tag and the end tag indicate a start and an end of the data being extracted under the extraction condition and allocated by the allocation process, i.e., the start and the end of the data set (s) having the common key name and becoming the data processing target. Namely, the start tag and the end tag specify a compressed data processing range and a data processing target range for the aggregation and so on.

Then, the data integration system 2 aggregates the values of the items 3 as the data processing target items, resulting in a calculated value “70” in the example of FIG. 6. Moreover, the data integration system 2 decompresses the compressed data and merges the data.

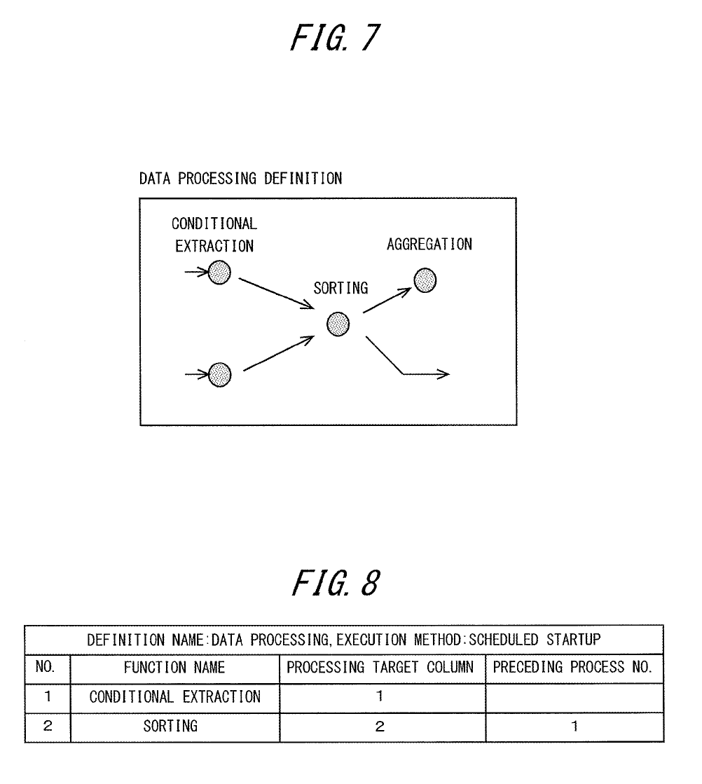

FIG. 7 illustrates a data processing definition setting screen displayed on the user interface of the data integration system 2. A user makes settings of the data processing such as designating the processing, e.g., the conditional extraction based on the predetermined extraction condition, the allocation, the aggregation and sets a data flow with respect to the data (the header information and the compressed data) acquired from the plurality of source systems 1 by operating the user interface of the data integration system 2.

FIG. 8 depicts data (database) in which the details of the data processing definitions set by the user interface in FIG. 7 are described in a table format. FIG. 8 is a table in which elements included in the data processing definitions set by the user interface in FIG. 7 are listed, but it does not mean that the data processing definitions are limited to the table format in FIG. 8. The data processing definitions in FIG. 8 include, e.g., a definition name, an execution method, a number, a function name, a processing target column and a preceding process number. A first row is a common information row in the table of FIG. 8.

The “Definition” of the common information row includes a name given to the data processing definition being set. The “Execution Method” includes an execution method of the process to be executed based on the data processing definition. In FIG. 8, “Scheduled Startup” is set as the execution method, but it does not mean in the embodiment that the process execution method is limited to the scheduled startup, and the startup may be exemplified such as a manual startup by the user and a startup being triggered by satisfying a predetermined condition.

The individual processes (processing-related information and values) included in the data processing definition are designated in respective rows from the second row onward in FIG. 8. However, the field names for the data in the respective rows from the third row onward are listed in the second row of the table in FIG. 8. The field names are information for explanations, but the data integration system 2 may not refer to the field names. Serial numbers of the respective rows is included in a “Number” field given in the leftmost column of the table. Values in the “Number” field are the serial numbers being referred to as preceding process numbers by subsequent processes. The information indicating the data processing method of the row concerned such as the conditional extraction, the allocation and the aggregation is stored in a “Function Name” field of the table in FIG. 8. The values designated as the item numbers of the data to be processed by the data processing methods specified in the “Function Name” field are stored in a “Processing Target Column” field of the table in FIG. 8. A number for designating the row in which to define the data processing method preceded by the data processing method of the row concerned stored in a “Preceding Process Number” field of the table in FIG. 8.

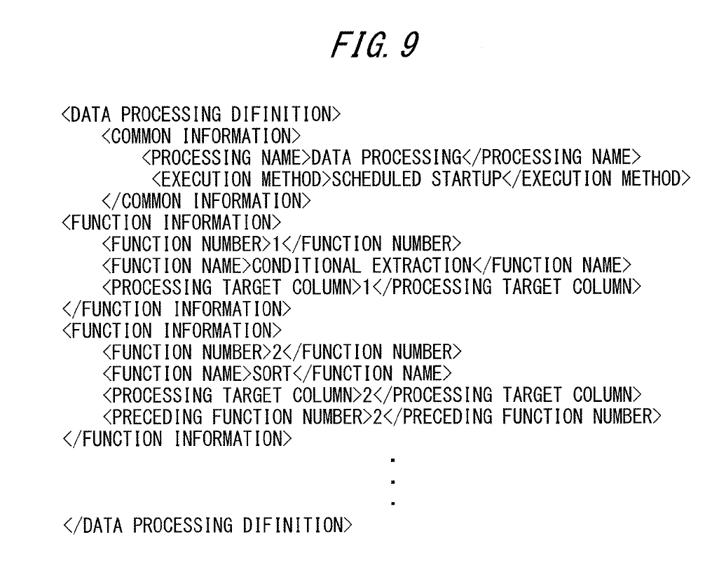

FIG. 9 illustrates data (database) in which the data processing definition in FIG. 8 is described in an XML (Extensible Markup Language) format. In FIG. 9, a tag set “<data processing definition> </data processing definition>” indicates that the XML-based description as illustrated in FIG. 9 is data processing definition. Here, the data processing definition further includes a tag set “<common information> </common information>” and a sequence of tag sets “<function information> </function information>”.

A tag set “<common information> </common information>” includes a tag set “<processing name> </processing name>” and a tag set “<execution method> </execution method>”. The tag set “<processing name> </processing name>” defines a name of “data processing”. In the example of FIG. 9, the “data processing” is a name given to the data processing definition. Further, a tag set “<execution method> </execution method>” defines the “scheduled startup”. The “scheduled startup” is already described in FIG. 8, and hence the explanation thereof is omitted here.

Moreover, the data processing definition in FIG. 9 includes a plurality of tag sets “<function information> </function information>”. Each tag set “<function information> </function information>” includes a tag set “<function number> </function number>”, a tag set “<function name> </function name>” and a tag set “<processing target column> </processing target column>”. The tag set “<function number> </function number>” defines a number being referred to by the tagged data “preceding function number” in the tagged data “function information” from the second onward as well as defining a serial number for identifying the tagged data “function information”. The tag set “<function name> </function name>” defines a processing type as one item of function information defined by the tag set “<function information> </function information>”. The tag set “<processing target column> </processing target column>” defines an item number of the processing target data in the tagged data “function information”. Further, the second tag set “<function information> </function information>” onward includes a tag set “<preceding function number> </preceding function number>”. The tagged data “preceding function number” is the same information as the “preceding process number” illustrated in FIG. 8, and designates the tagged data “function information” being precedent to the relevant tagged data “function information”.

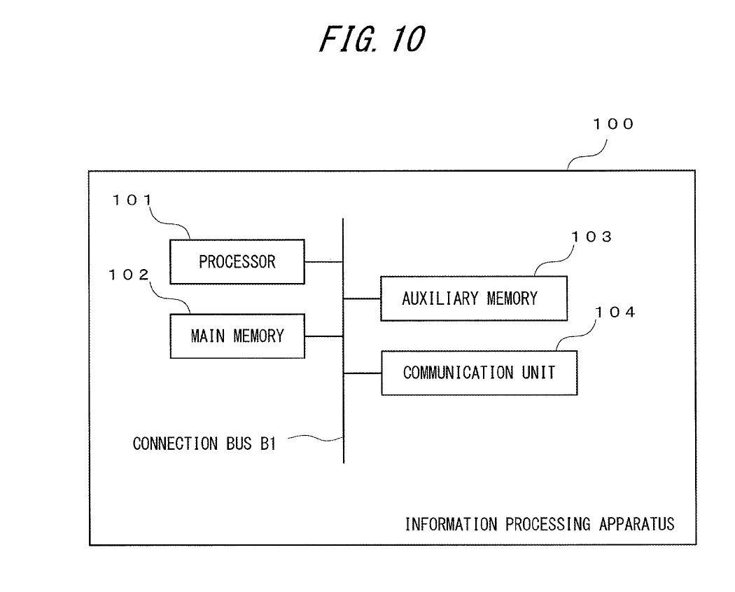

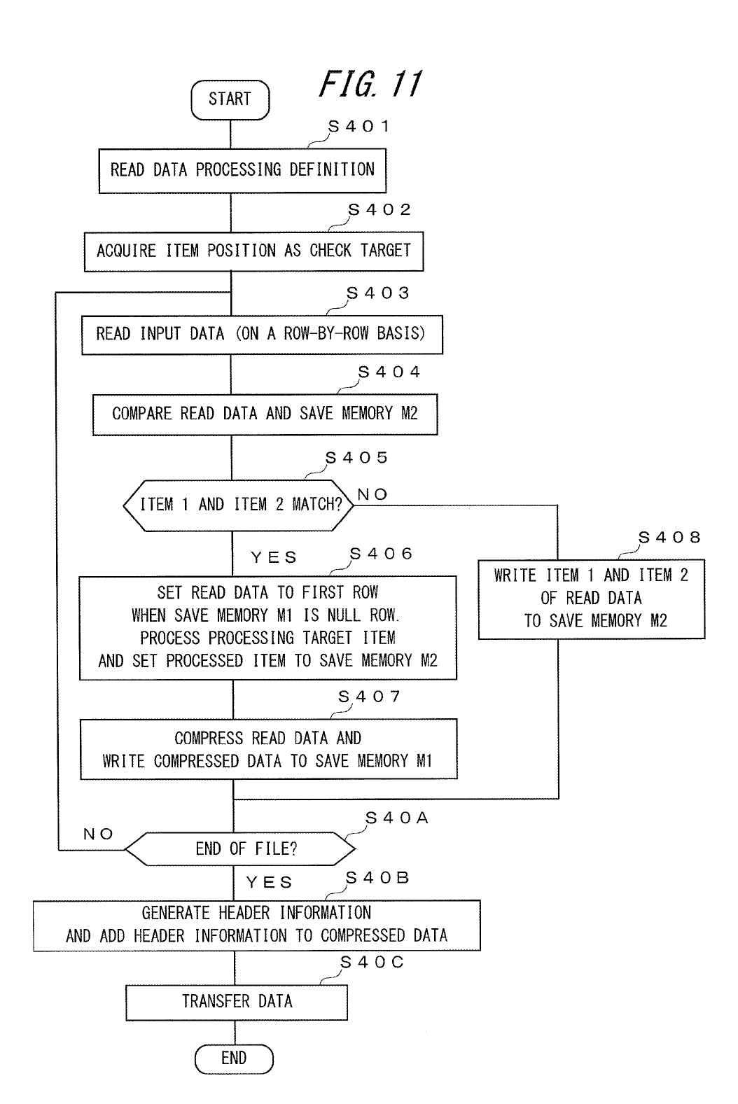

FIG. 10 illustrates an information processing apparatus 100 to execute the processes as the source system 1, the data integration system 2 or the target system 3. The information processing apparatus 100 includes a CPU (Central Processing Unit) 101, the main storage unit 102, the auxiliary storage unit 103 and the communication unit 104. The CPU 101 executes a variety of information processes by executing the computer program deployed in an executable manner on the main storage unit 102. The main storage unit 102 stores data including computer programs executed by the CPU 101 and data processed by the CPU 101. The main storage unit 102 is exemplified by a Dynamic Random Access Memory (DRAM), a Static Random Access Memory (SRAM), a Read Only Memory (ROM) etc. Further, the auxiliary storage unit 103 is used as a storage area serving as an auxiliary of the main storage unit 102, and the auxiliary storage unit 103 stores the computer programs executed by the CPU 101 and the data processed by the CPU 101. The auxiliary storage unit 103 is exemplified by a hard disk drive, a Solid State Disk (SSD) etc. The communication unit 104 is connected to a network and performs the communications with other information processing apparatuses. It is noted that the information processing apparatus 100 may be provided with, though omitted in FIG. 10, a detachable storage medium drive. A detachable storage medium is exemplified such as a Blu-ray disc, a Digital Versatile Disk (DVD), a Compact Disc (CD) and a flash memory card.

FIG. 11 depicts processes of the agents 11 of the source system 1. It is noted that a save memory M1 and a save memory M2 are provided on the main storage unit 102 in the processes of FIG. 11. The save memory M1 retains the compression target data. On the other hand, the save memory M2 retains the assortment of the data, i.e., the string of key names illustrated in FIG. 4. The key name in the save memory M2 is null data at an initial stage. Further, an assumption in the following processes is that the key names are values of the item 1 and the item 2. However, it does not mean that the number of items which are key names is limited to “2”. The save memory M2 may retain the key names including three or more items. Furthermore, the save memories M1 are provided individually in the way of being associated with the different key names.

The agents 11, at first, reads the data processing definition (S401). The CPUs 01 of the source systems 1A, 1B function as acquiring units to execute the processes of the agentsn 11 in S401. Then, the agents 11 acquire item positions as check targets in the conditional extraction (S402). Next, the agents 11 read the input data (S403). It may be sufficient that the agents 11 read the input data on a row-by-row basis (one row corresponds to one record). However, it does not mean that the processes of the agents are limited to the processes in FIG. 11.

Subsequently, the agents 11 compare the data read in S403 with the key names in the save memory M2 (S404, S405). Then, when the item 1 and the item 2 match with the key names in the save memory M2, the agents 11 additionally write the read-in data in the save memory M1 associated with the key names. However, when the save memory M1 associated with the key names is a “null” row, the agents 11 set values of the read-in data in header fields (S406). Furthermore, in a process of S406, the agents 11 perform the data processing of the processing target item in the read-in data. For example, the agents 11 performs the data processing (e.g., calculating a subtotal etc.) of the processing target item in the read-in data, and sets the processed data in the save memory M2. It is noted that the processed data (subtotal data etc.) of the item, which is set in the save memory M2, is then set in the header information (header record). The CPUs 101 of the source systems 1A, 1B function as segmenting units to execute the process of the agents 11 in S406. Moreover, the process in S406 is one example of a step of generating a segmented data processing value. Further, the processing target item is one example of a processing item. The data (the subtotal data etc.) of the item set in the save memory M2 is one example of a segmented data processing value. It is noted that a series of processes described above may take a mode of retaining the key names also in the save memory M1 after retaining the key names in the save memory M2, and retaining the segmented data processing values in the save memory M1 in the way of being associated with the key names retained in the save memory M1.

Furthermore, the agents 11 compress the data and stores the compressed data in the save memory M1 (S407). The CPUs 101 of the source systems 1A, 1B function as compression units to execute the process in S407.

On the other hand, when at least one of the item 1 and the item 2 does not match with the key name in the save memory M2 in S405, the agents 11 set the item 1 and the item 2 of the read-in data as new key names in the save memory M2 (S408). The CPUs 101 of the source systems 1A, 1B function as extraction units to execute the process in S408. Moreover, the agents 11 allocate a region (field) for the save memory M1 associated with the newly set key name on the main storage unit 102.

Next, the agents 11 determine whether the present read-in position is at an end of the file or not (S40A). When the present read-in position is not at the end of the file, the agents 11 return the processing to S403, and continues the processing for the next row (next record). Whereas when the present read-in position is at the end of the file, the agents 11 generate the record of header information based on the information in the save memory M2, and adds the generated record to a compression memory of the save memory M1, thereby generating data to be transmitted to the data integration system 2 (S40B). The CPUs 101 of the source systems 1A, 1B function as attaching units to execute the process in S40B. It is noted that the mode of retaining the key names also in the save memory M1 after retaining the key names in the save memory M2 and retaining the segmented data processing values in the save memory M1 in the way of being associated with the key names retained in the save memory M1, enables the process in S40B to be simplified because of retaining the key names and the segment processing values together with the read-in data in the save memory M1.

Then, the agents 11 transfer the compressed data attached with the record of header information in S40B to the data integration system 2 via the communication unit 104 etc. illustrated in FIG. 10 (S40C). The CPUs 101 of the source systems 1A, 1B function as communication units configured to transmit segmented compressed data to an information processing apparatus to execute the process in S40C.

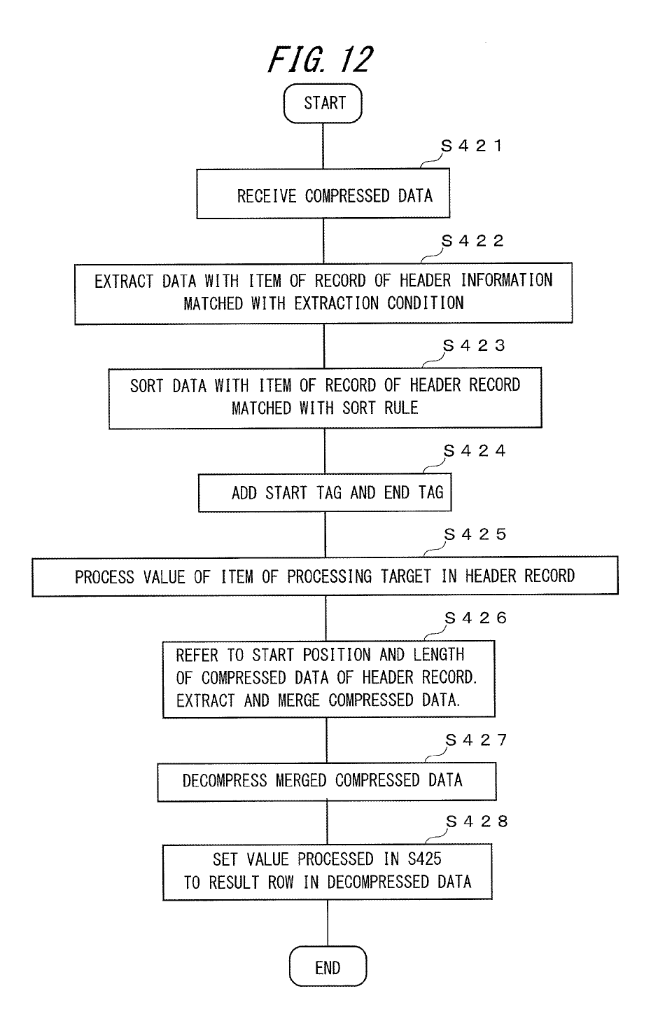

FIG. 12 depicts processes of the data integration system 2. In the processes in FIG. 12, when the data integration system 2 receives the compressed data via the communication unit 104 illustrated in FIG. 10, the data integration system 2 starts processing (S421). The CPUs 101 of the data integration system 2 function as data receiving units to execute the process in S421. Step S421 is also one example of a step of receiving segmented compressed data.

Next, the data integration system 2 extracts the compressed data attached with the record of header information together with the record of header information including the predetermined item which matches with the predetermined extraction condition (S422). Hereinafter, the compressed data attached with the record of header information is simply referred to as data. For example, in the example of FIG. 5, the data integration system 2 extracts the data including the header information with “Item 1=Member”. Further, the data integration system 2 sorts the data in accordance with the allocation target items of the record of header information. For instance, in the example of FIG. 5, the data integration system 2 sorts the data in accordance with “Item 2=Destined for Tokyo” and “Item 2=Destined for Osaka” (S423). The data integration system 2 continues to execute the processes in S422 and S423 until the processes reach the end of the received compressed data.

Then, the data integration system 2 attaches a start tag and an end tag to the allocated data (S424). Moreover, the data integration system 2 processes the processing target items in the record of header information (S425). For example, the data integration system 2 aggregates the values of the item 3. Step S425 is one example of a step of executing a process for received segmented compressed data by use of a segmented data processing value without decompressing the segmented compressed data.

Further, the data integration system 2 extracts the compressed data by referring to the start position and the length of the compressed data in the record of header information, and merges the extracted compressed data (S426). Furthermore, the data integration system 2 decompresses the merged compressed data (S427). Then, the value of the processed item (e.g., the totalized value etc. of the item 3) is set in a processing target storage field of the decompressed data (S428). The CPUs 101 of the data integration system 2 function as processing units to execute the processes in S422 to S428.

According to the information processing system of the embodiment as described above, in the source system 1, the agents 11 receive the distribution of the data processing definitions from the data integration system 2. Then, in accordance with the data processing definitions, the agents 11 acquire the processing target items of the processing executed by the data integration system 2 and the items as the key names for the processing target items, and set the items for assorting the data. Subsequently, in accordance with the items for assorting the data, the agents 11 acquire the key names from the accumulated data, then segment the data, and compress the segmented data, thereby generating the segmented compressed data. Furthermore, the agents 11 perform the data processing such as aggregating the processing target items (values), generate the record of header information by use of the key names and the processed values of the processing target items, then attach the generated record of header information to the segmented compressed data, and thus transfer the segmented compressed data with the header information to the data integration system. Accordingly, the data integration system 2 receiving the transferred segmented compressed data is enabled to extract the processing target data from the segmented compressed data attached with the record of header information, to allocate the data and to process the processing target items based on the key names set in the record of header information and the processed values (such as the subtotalized value when the processing type is the totalization) of the processing target items set in the record of header information without decompressing the segmented compressed data. Moreover, the data integration system 2 can transfer the allocated data to the target system 3 etc. without decompressing the segmented compressed data. Hence, the data integration system 2 can reduce the loads on the system resources, the loads being caused by decompressing the data and again compressing the data.

Further, the data integration system 2 can acquire the items matching with the extraction conditions and the allocation determining items from the record of header information. Thus, the data integration system 2 according to the embodiment does not have to, in contrast to the comparative example, search for the items matching with the extraction conditions and the allocation determining target items for all the data.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

According to one aspect, the compressed data can be processed while restraining the load on the information processing from rising.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A data processing apparatus to transmit data including a plurality of items to an information processing apparatus and to cause the information processing apparatus to process the data, the data processing apparatus comprising:
a processor; and
memory configured to store a program to instruct the processor to perform:
acquiring processing-related information including a designation of a processing target item from the information processing apparatus;
extracting, from the data to be transmitted, an item value associated with an item to which the information processing apparatus refers when the information processing apparatus processes the data to be transmitted based on the processing-related information;
generating compressed data by compressing the data to be transmitted;
generating attached information including the extracted item value; and
transmitting the compressed data attached with the attached information to the information processing apparatus.

2. The data processing apparatus according to claim 1, wherein the program further instructs the processor to perform:
generating segmented data by assorting the data to be transmitted based on the extracted item value,
generating segmented compressed data by compressing the segmented data,
generating a segmented data processing value by processing a value of a processing item in the segmented data corresponding to a processing item with the item value being processed by the information processing apparatus in the data to be transmitted, and
setting the segmented data processing value in the attached information.

3. An information processing apparatus to receive compressed data from a data processing apparatus and to process the compressed data, the information processing apparatus comprising:
a processor; and
memory configured to store a program to instruct the processor to perform:
transmitting processing-related information including a designation of a processing target item in pre-compressing data to the data processing apparatus, and to receive the compressed data attached with attached information including an item value corresponding to an item to be referred to when the processing target data extracted from the pre-compressing data based on the processing-related information from the data processing apparatus is processed; and
processing the compressed data based on the attached information.

4. The information processing apparatus according to claim 3, wherein the program further instructs the processor to perform:
receiving segmented compressed data which is segmented and compressed based on the item value by the processing apparatus; and
executing processing of the received segmented compressed data by use of a segmented data processing value without decompressing the segmented compressed data, wherein the segmented data processing value is obtained by processing a value corresponding to an item designated as a processing target item in the processing-related information with respect to the segmented data before the segmented compressed data is compressed and the segmented data processing value is included in the attached information.

5. A data processing method by which a data processing apparatus to transmit data including a plurality of items to an information processing apparatus and to cause the information processing apparatus to process the data, the data processing method comprising:
acquiring, by a computer, processing-related information including a designation of a processing target item from the information processing apparatus;
extracting, by the computer, from the data to be transmitted, an item value corresponding to an item to which the information processing apparatus refers when the information processing apparatus processes the data to be transmitted based on the processing-related information;
generating, by the computer, compressed data by compressing the data to be transmitted;
generating, by the computer, attached information including the extracted item value; and
transmitting, by the computer, the compressed data attached with the attached information to the information processing apparatus.

6. The data processing method according to claim 5, further comprising:
generating, by the computer, segmented data by assorting the data to be transmitted based on the extracted item value,
wherein the generation of the compressed data includes generating segmented compressed data by compressing the segmented data,
the generation of the segmented data includes generating a segmented data processing value by processing a value of a corresponding processing item in the segmented data with respect to a processing item with an item value being processed by the information processing apparatus in the data to be transmitted, and
the generation of the attached information includes setting the segmented data processing value in the attached information.

7. An information processing method by which an information processing apparatus to receive compressed data from a data processing apparatus and to process the compressed data, the information processing method causing the information processing apparatus to execute:
transmitting processing-related information including a designation of a processing target item in pre-compressing data to the data processing apparatus;
receiving the compressed data attached with attached information including an item value corresponding to an item to be referred to when the information processing apparatus processes the processing target data extracted from the pre-compressing data based on the processing-related information from the data processing apparatus; and
processing the compressed data based on the attached information.

8. The information processing method according to claim 7, wherein the reception of the segmented compressed data includes receiving the segmented compressed data segmented and compressed based on the item value by the data processing apparatus,
the attached information includes a segmented data processing value obtained by processing a processing value corresponding to an item designated as a processing target item in the processing-related information with respect to the segmented data before the segmented compressed data is compressed, and
the processing of the compressed data based on the attached information includes executing a process for the received segmented compressed data by use of the segmented data processing value without decompressing the segmented compressed data.

9. A non-transitory computer-readable recording medium storing a program that causes a data processing apparatus to transmit data containing a plurality of items to an information processing apparatus and to cause the information processing apparatus to process the data to execute a process comprising:
acquiring processing-related information including a designation of a processing target item from the information processing apparatus;
extracting from the data to be transmitted, an item value corresponding to an item to which the information processing apparatus refers when the information processing apparatus processes the data to be transmitted based on the processing-related information;
generating compressed data by compressing the data to be transmitted;
generating attached information including the extracted item value; and
transmitting the compressed data attached with the attached information to the information processing apparatus.

10. The non-transitory computer-readable recording medium according to claim 9, wherein the program further causes the data processing apparatus to execute generating segmented data by assorting the data to be transmitted based on the extracted item value,
the generation of the compressed data includes generating segmented compressed data by compressing the segmented data,
the generation of the segmented data includes generating a segmented data processing value by processing a value of a corresponding processing item in the segmented data with respect to a processing item with an item value being processed by the information processing apparatus in the data to be transmitted, and
the generation of the attached information includes setting the segmented data processing value in the attached information.

11. A non-transitory computer-readable recording medium storing a program that causes an information processing apparatus to receive compressed data from a data processing apparatus and to process the compressed data to execute a process comprising:
transmitting processing-related information including a designation of a processing target item in pre-compressing data to the data processing apparatus;
receiving the compressed data attached with attached information including an item value corresponding to an item to be referred to when the information processing apparatus processes the processing target data extracted from the pre-compressing data based on the processing-related information from the data processing apparatus; and
processing the compressed data based on the attached information.

12. The non-transitory computer-readable recording medium according to claim 11, wherein the reception of the segmented compressed data includes receiving the segmented compressed data segmented and compressed based on the item value by the data processing apparatus,
the attached information includes a segmented data processing value obtained by processing a processing value corresponding to an item designated as a processing target item in the processing-related information with respect to the segmented data before the segmented compressed data is compressed, and
the processing of the compressed data based on the attached information includes executing a process for the received segmented compressed data by use of the segmented data processing value without decompressing the segmented compressed data.
